(19) United States
(12) Patent Application Publication
(10) Pub. No.: US 2005/0288928 A1
(43) Pub. Date: Dec. 29, 2005

(54) Memory efficient decoding graph compilation system and method

(76) Inventors: Vladimir Bergl, Praha (CZ); Miroslav Novak, Mohegan Lake, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/875,461

(22) Filed: Jun. 24, 2004

(51) Int. Cl. G10L 15/08

(52) U.S. Cl. 704/242

(57) ABSTRACT

A system and method for building decoding graphs for speech recognition are provided. A state prefix tree is given for each unique acoustic context. The prefix trees are traversed to select a subtree of arcs and states for each state of the word grammar G to be added to a final decoding graph wherein the states and arcs are added incrementally during the traversing step such that the final graph is constructed deterministically and minimally by the construction process.

### BACKGROUND

1. Technical Field

The present embodiments include systems and methods for efficient memory usage in speech recognition, and more particularly to efficient systems and methods for the compilation of static decoding graphs.

2. Description of the Related Art

The use of static hidden Markov Model (HMM) state networks (search graphs) is considered one of the most speed efficient approaches to implementing synchronous (Viterbi) decoders. The speed efficiency comes not only from the elimination of the graph construction overhead during the search, but also from the fact that global determinization and minimization provides the smallest possible search space.

Determinization and minimization procedures are known in the art and provide a reduction in a final graph for decoding speech. Minimization refers to the process of finding a graph representation, which has a minimum number of states. Determinization refers to the process of finding state sequences where each state sequence produces a unique label sequence (labels are associated with arcs). The graphs referred to herein are generally search graphs, which indicate a solution or a network of possibilities for a given utterance or speech.

The use of finite state transducers (FST) has become popular in the speech recognition community. Finite state transducers (FST) provide a solid theoretical framework for the operations needed for search graph construction. A search graph is the result of a composition
C o L o G (1)
where G represents a language model, L represents a pronunciation dictionary and C converts the context independent phones to context dependent HMMs. The main problem with direct application of the composition step is that it can produce a non-deterministic transducer, possibly much larger than its optimized equivalent. The amount of memory needed for the intermediate expansion may be prohibitively large given the targeted platform.

Many techniques proposed for efficient search graph composition restrict the phone context to triphones, since the complexity of the task grows significantly with the size of the phonetic context used to build the acoustic model, particularly when cross-word context is considered. For large cross-word contexts, auxiliary null states may be employed using a bipartite graph partitioning scheme. In a prior art suggested approximative partitioning method, the most computationally expensive part is vocabulary dependent. Determinization and minimization is applied to the graph in subsequent steps.

Another technique builds the phone to state transducer C by incremental application of tree questions one at a time. The tree can be built effectively only up to a certain context size, unless it is built for a fixed vocabulary. This method still relies on explicit determinization and minimization steps in the process of the composition of the search graph.

### SUMMARY

A system and method for building decoding graphs for speech recognition are provided. A state prefix tree is given for each unique acoustic context. The prefix trees are traversed to select a subtree of arcs and states to be added to a final decoding graph wherein the states and arcs are added incrementally during the traversing step such that the final graph is constructed deterministically and minimally by the construction process.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for left context graph building;

FIG. 2 is a block/flow diagram showing a system/method for selecting subtrees from a prefix tree in accordance with one illustrative embodiment;

FIG. 3 is a graph of a prefix tree showing selection of leaves corresponding to words in accordance with the diagram of FIG. 2;

FIG. 4 is a graph of the prefix tree of FIG. 3 showing selection of parent leaves connected to end leaves during traversal of the prefix tree and the pushing of weight costs toward a root leaf;

FIG. 5 is a graph of the prefix tree of FIG. 4 showing a scenario where a parent leaf is merged in a final graph; and

FIG. 6 is a graph of the prefix tree of FIG. 5 showing the traversal and selection of all active leaves in the prefix tree to complete the subtree for the final graph.

### DETAILED DESCRIPTION OF PREFERRED EMBODIMENTS

The present disclosure provides an efficient technique for the compilation of static decoding graphs. These graphs can utilize full word of cross-word context, either left or right. The present disclosure will illustratively describe use of left cross-word contexts for generating decoding graphs. One emphasis is on memory efficiency, in particular to be able to deploy the embodiments described herein on platforms with limited resources. Advantageously, the embodiments provide an incremental application of the composition process to efficiently produce a weighted finite state acceptor, which is globally deterministic and minimized with the maximum memory need during the composition, essentially the same as that needed for the final graph. Stated succinctly, the present disclosure provides a system and method, which builds a final graph in a way that provides a deterministic and minimized result by virtue of the process, and not by employing separated deterministic and minimization algorithms.

Suitable methods considered herein include vocabulary independence, maximal memory efficiency and the ability to trade speed for complexity. By vocabulary independence, the vocabulary can be changed without significantly affecting the efficiency of the algorithm. In some situations, the grammar G is constructed before the recognition starts, defining the vocabulary. For example, in dialog systems the grammars are composed dynamically in each dialog state. In another case, the user is allowed to customize the application by adding new words.

A more complex model can be used for greater recognition accuracy, e.g. wider cross-word context with a trade-off against speed of the graph building. However, if speed is needed as well, one can use a model with reduced context size to meet the requirements.

Use of the left cross-word context is described, however right cross-word context can also be employed with increased complexity of right context cross-word modeling. IBM acoustic models are typically built with 11-phone context (including the word boundary symbol), which means that within the word the context is ±5 phones wide in each direction and the left cross-word context is at most 4 phones wide.

It should be understood that the elements shown in FIGS. may be implemented in various forms of hardware, software or combinations thereof. Preferably, these elements are implemented in software on one or more appropriately programmed general-purpose digital computers having a processor and memory and input/output interfaces. In addition, advantageously, in accordance with the teachings herein, memory buffers and memory storage may be provided as ROM, RAM or a combination of both. Each block or blocks may comprises a single module or a plurality of modules for implementing functions in accordance with the illustrative embodiments described herein with respect to the following FIGS.

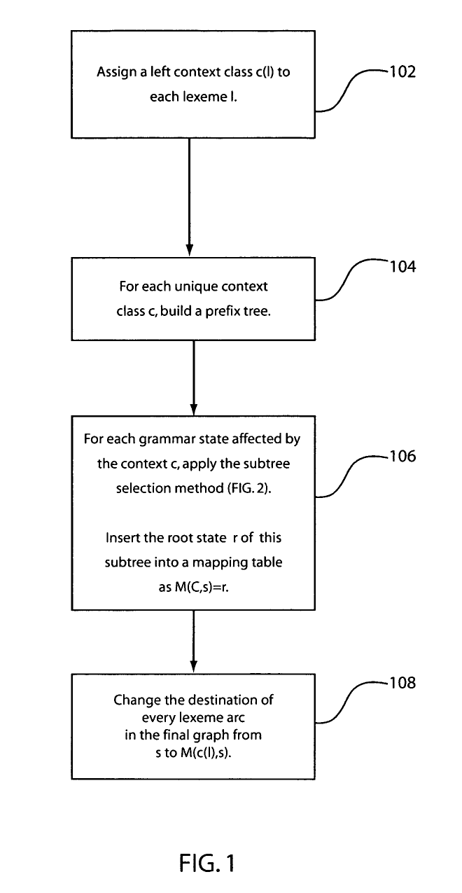

Referring now to the drawings in which like numerals represent the same or similar elements and initially to FIG. 1, a flow/block diagram is illustratively shown for building decoding graphs and selecting subtrees in accordance with exemplary embodiments. The system/method illustrated in FIG. 1 provides for the traversal of one or more prefix graphs to select a subtree from the prefix graph for decoding speech. Decoding graphs or search graphs include nodes, which represent states in an HMM sequence. The nodes are associated/connected by edges or arcs. A root is a node with no parent. Nodes are arranged in predetermined levels, these levels can be thought of as generations with children extending from a parent and grandparent nodes. End nodes are leaves and have no children.

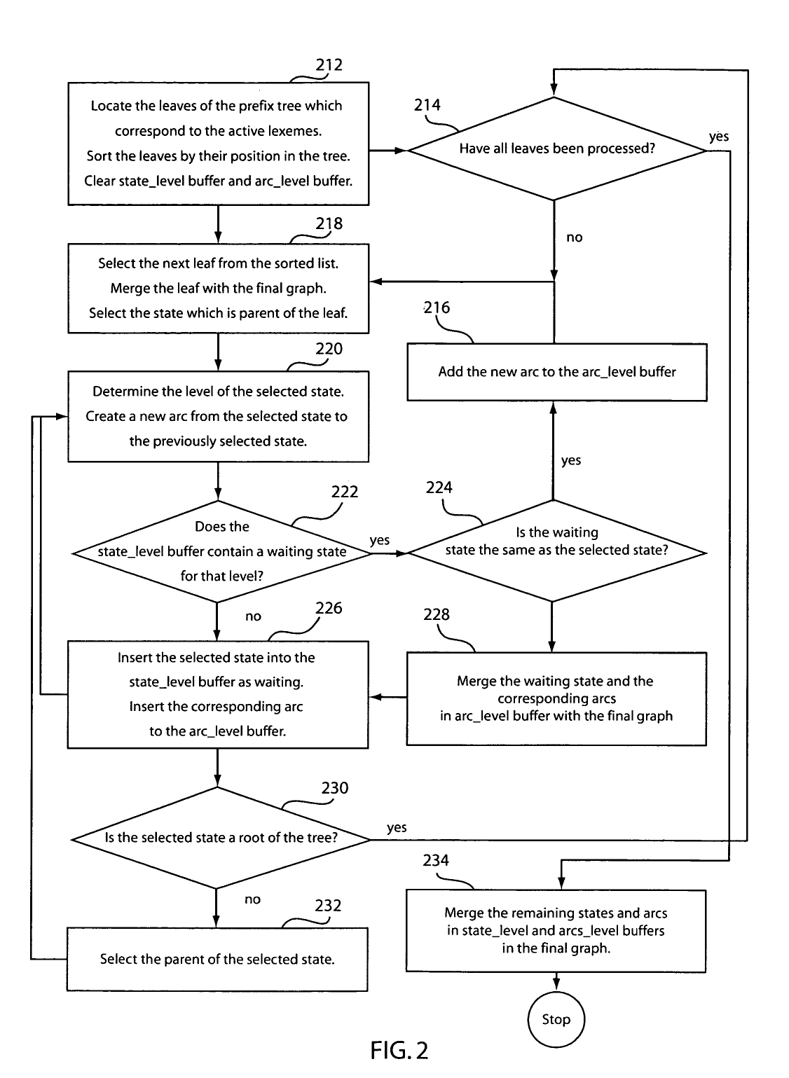

Referring to FIG. 1, a process for building a left context model includes the following steps. In block 102, a set of all left context classes is constructed given all pronunciation variants (called lexemes) of active words and the cross-word context size. A map C(1) is created which assigns a context class to each lexeme. In block 104, for each context class c build a prefix tree T, apply a subtree selection algorithm (FIG. 2) to each state s of G affected by this context in block 106. Also in block 106, insert the root of each such subtree into a map M(c, s). In block 108, for each arc in the final graph with a lexeme label 1, change its destination from s to M(C(1), s).

The set of left context classes is constructed by simply enumerating all phone k-tuples observed in all lexemes. This is an upper bound as some phone sequences will have the same left context effect. As the graph is built, those classes with a truly unique context will be automatically found by the minimization step. For this reason, it is preferred to perform the connection of each lexeme arc to its corresponding unique tree root in a separate final step, after all trees for all contexts have applied to the graph.

For state equivalence testing performed during the incremental build, a hash table is preferably employed used. The state is represented by a set of arcs, each arc may be represented by a triple (destination state, label, cost). To minimize the amount of memory used by the hash table, the hash was implemented as a part of the algorithm. In a stand-alone hash implementation, the key value is stored in the hash table for conflict resolution. This would effectively double the amount of memory needed to store the graph. Advantageously, the memory structure provided herein for the graph state representation includes records related to the hashing, i.e. a pointer for the link list construction and the hash lookup value (the graph state id). In this way, the hashing adds only 8 bytes to each graph state.

Referring to FIG. 2, a subtree selection method and system is presented for block 106 of FIG. 1. In block 212, leaves of a prefix tree, which correspond, to active lexemes are located. Once located the leaves are sorted by their position in the tree. The position in the tree is based on the number assigned to each node. The assignment is done in such a way which assures the all descendants of any given node have a number which is higher then the number of the node but lower than the number of its next sibling. In one embodiment, state and arc level buffers are cleared to initialize these buffers for the remaining steps of the method. At the end of the method, a final graph will be provided which is both deterministic and minimized by virtue of the construction of the graph, instead of applying deterministic and minimization algorithms to an entire tree.

In block 214, a check is performed to determine if all leaves have been processed. If all the leaves have been processed, the remaining states and arcs in the states and arc buffers are merged with a final graph in block 234. Otherwise, in block 218, a next leaf is selected from the sorted list of leaves. The selected leaf is merged with the final graph. Then, the state, which is a parent node to the child leaf is selected. In block 20, the level of the selected state is determined and a new arc is created from the selected state (in this case the parent node) to the previously selected state (child).

In block 222, a check is performed to determine whether the state level buffer includes a waiting state for that level. A waiting state is a conditional state where the outcome of processing other nodes may still affect the disposition of the node in the waiting state. The waiting state is used to determine if any other processing has used a state at the presently achieved level in the graph. In other words, has any processing at the parent level been previously performed? If it has then that state (or node) is in a waiting state. If a waiting state is included, then in block 224, it is determined whether the waiting state is the same as a current selected state. If the selected state is the same as the waiting state, a new arc is added to the arc level buffer going toward the root of the tree in block 216, and the process returns to block 218 where the next leaf or state is considered.

If the waiting state is not the same as the selected state then the waiting state and corresponding arcs are merged from the arc level buffer into the final graph in block 228. By virtue of the setup of the prefix tree, the waiting state and the arcs can be committed to the final graph at this early stage since all possibilities have been considered previously for the waiting state. If the state level buffer does not include a waiting state (from block 222) or the waiting state has been merged with the final graph (block 228), then, the selected state is added to the state level buffer as waiting and the corresponding arcs are added to the arc level buffer, in block 226. Processing returns to block 226 until all leaves of that level are considered and processed.

In block 230, a determination is made as to whether the state is a root of the tree. If it is the root, processing continues with block 214. Otherwise, in block 232, a parent of the selected state is selected and processing returns to block 220.

By traversing the states and arcs in this way, a final graph is constructed incrementally and having the characteristics of being deterministic and minimized. This is particularly useful in memory-limited applications.

Deterministic acyclic finite state automata can be built with high memory efficiency using this incremental approach. The final graph is not necessarily acyclic (certainly not if it is an n-gram model), but the cyclic graph minimization is not needed assuming that the grammar G is provided in its minimal form.

One distinct feature of present method and system is that the amount of memory needed to store the graph at any point will not exceed the amount of memory needed for the final graph. It should be understood that the actual graph representation during the composition needs more memory per state than the final representation during the decoding, but it is fair to say that the memory need is O(S+A), where S is the number of states and A is the number of arcs of the final graph.

The efficiency of the present disclosure has been achieved by using finite state actuators (FSA) rather than finite state transducer (in the prior art). Using acceptors rather than transducers makes the operations such as determinization and minimization less complex. One concept includes the combination of all steps (composition, determinization, minimization and weight pushing) into a single step.

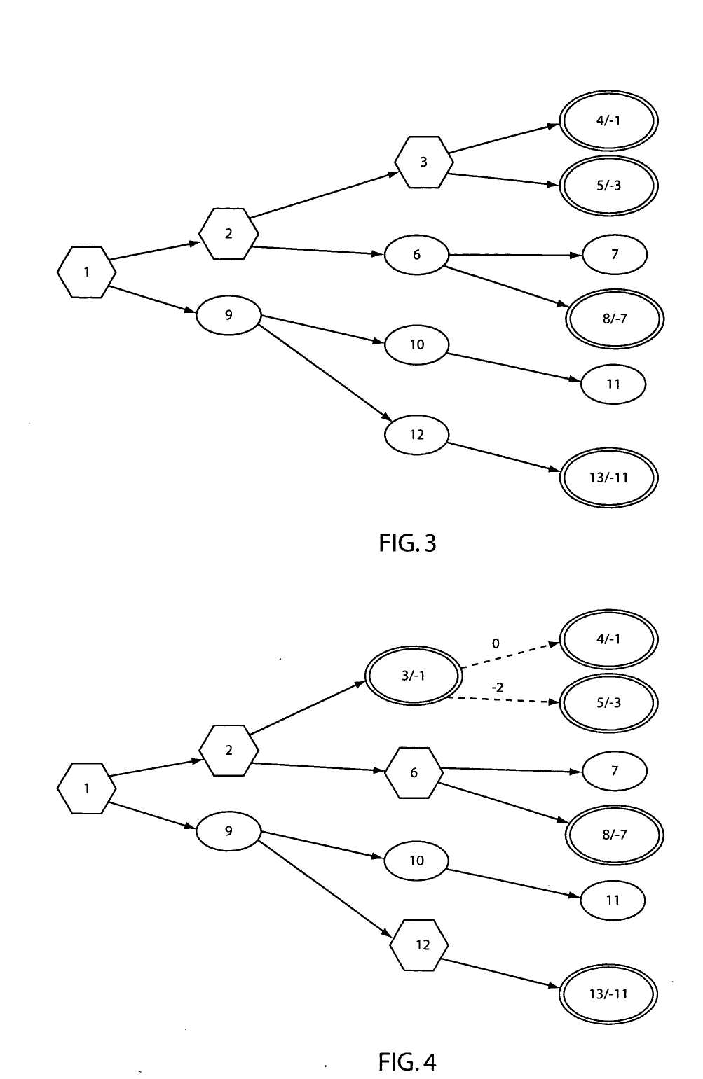

The method/system described with reference to FIG. 2 can be implemented in accordance with an illustrative example described with reference to FIGS. 3-6.

A deterministic prefix tree T is constructed which maps HMM state sequences to pronunciation variants of words (lexemes) in G. Each unique arc sequence representing an HMM state sequence is terminated by an arc labeled with the corresponding lexeme.

All arcs leaving a particular state of G are replaced by a subtree of T with the proper scores assigned to the subtree leaves. The operation which performs this replacement on all states of G is denoted as RT(G).

The resulting FSA is deterministic. The minimization (including weight pushing) is also included into the subtree selection so the resulting FSA is a minimized as well.

This minimization is done locally, which means that its extent is limited to subtrees leading to same target states of G. This is due to the fact that the algorithm preserves states and arcs of G. If a and b are two different states of G, then:
a≠b→L(Gₐ)≠L(G_{b})→L(R_{T}(Gₐ))≠L(R_{T}(G_{b})), (2)
Where Gₐ is maximal connected sub-automaton of G with start state “a” and L(Gₐ) is the language generated by Gₐ. In another words, if G is minimized, the algorithm cannot produce a graph, which would allow the original states to merge. This has important implications. To minimize the composed graph, only local minimization needs to be performed, e.g., any two states of the composed graph need to be considered for merge only if they lead to the same sets of states of G. This minimization is acyclic and thus very efficient (algorithms with complexity O(N+A) do exist). The subtree selection is applied incrementally to each state of G. As the states of the subtree are processed, they are immediately merged with the final graph in a way, which preserves the final graph minimal.

It should be mentioned that the minimized FSA may be suboptimal in comparison to its equivalent FST form, since the transducer minimization allows input and output labels to move. While this minimization can still be performed on the constructed graph, it is avoided for practical reasons as it is preferable to place the lexeme labels at the word ends.

The system and method use a post-order tree traversal. Starting at the leaves, each state is visited after all of its children had been visited. When the state is visited, the minimization step is performed, e.g., the state is checked for equivalence with other states, which are already a part of the final graph. Two states are equivalent if they have the same number of arcs and the arcs are pair-wise equivalent, i.e. they have the same label, cost and destination state. If no equivalent state is found, than the state is added to the final graph. Otherwise, the equivalent state is used. A hash table may be used to perform the equivalence test efficiently.

In useful implementations of the post order processing, account is taken that only a subset of the tree, defined by the selected leaves corresponding to the active lexemes, needs to be traversed. The node numbering follows pre-order traversal. The index (number) of each leaf corresponds to one lexeme. Each node also carries information about its distance to the root (tree level).

One aspect of the minimization may include weight pushing. This concept fits naturally in the postorder processing framework in accordance with the embodiments described herein. The costs are initially assigned to selected leaves. As the state of the prefix tree are visited, the cost in pushed towards the root using algorithm described in the prior art.

Referring to FIGS. 3-6, a subtree selection system/method will be illustratively described based on an example. At any step during the process, each state can be in one of the three conditions: not visited (circle), visited but marked as waiting to be tested for equivalence (hexagon) or merged with the final graph (double circle). At any time, only one state in each level can be marked as waiting. In FIG. 3, active leaves of the tree are marked and assigned their LM scores (log likelihoods). These leaves can be immediately marked (as indicated by numbers) as merged, since they are part of G and will appear in the final graph. For the example, states include numbers and arcs or edges connect states. States also include negative numbers, which indicate weighting costs to traverse between states.

Starting with the top leaf, in this case, leaf 4, the tree is traversed towards a root (1), and all states along the path are marked as waiting (hexagons). When the second leaf is processed, in FIG. 3, its parent state (3) is already marked as waiting (hexagons), so the traversal towards the root (1) stops there.

In FIG. 4, the level of the parent state is examined for leaf (6) (the state (7) is not visited because it does represent an active leaf). There already exists a marked state at that level (state 3), which is not a parent of this leaf (6). This means that all children of the marked state (3) have already been merged with a final graph, so this state (3) can be added to the graph as well. The scores of all children states (4 and 5) are pushed towards this state (3) and the appropriate scores of all arcs are computed. After this state has been merged with the graph, the state (6) is marked as waiting at this tree level. The process is repeated for every parent until either the tree root or a waiting parent state is reached.

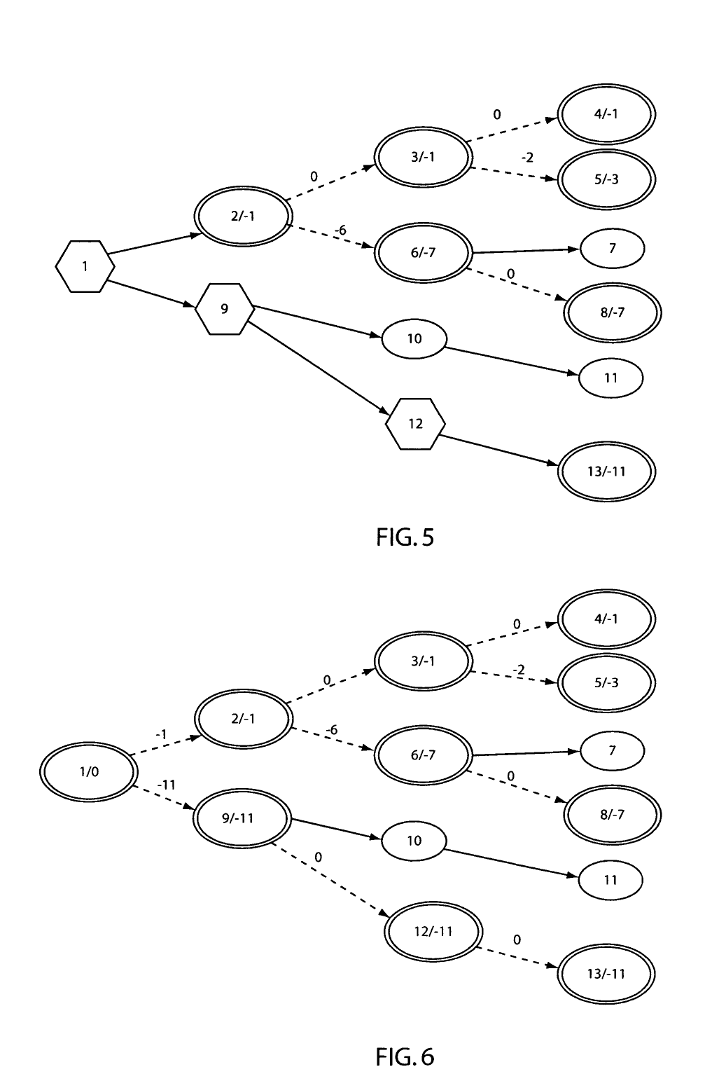

The same process is performed in FIG. 5, as the last active leaf (2) is processed. Finally in FIG. 6, after all active leaves have been processed, all remaining waiting states are merged with the final graph. It can be clearly seen in FIG. 4 that only those states, which became a part of the final graph were visited. In this way, the final graph is the result of limited processing (only leaves, which are relevant are visited), and the incremental processing provides a final graph that is both deterministic and minimized as a result of the procedure.

The upper bound on the amount of memory needed to traverse the tree is proportional to the depth of the tree times maximum number of arcs leaving one state. The memory in which the tree is stored does not need write access and neither the memory nor the computational cost of the selection depends directly on the size of the whole tree. In situations where the vocabulary does not change or when a large vocabulary can be created to guarantee the coverage in all situations, the tree can be precompiled and stored in ROM or can be shared among clients through shared memory access. Since ROM is cheaper, the present disclosure provides the ability to mix ROM and RAM memories in a way that can optimize memory efficiency and reduce cost.

In left cross-word context modeling, instead of one prefix tree a new tree needs to be built for each unique context. The number of unique contexts theoretically grows exponentially with the number of phones across the word boundary. In practice, this is limited by the vocabulary. The number of phones inside a word, which can be affected by the left context does not have a significant effect on the complexity of the algorithm.

After a final graph has been determined, the final graph is employed in decoding or recognizing speech for utterance.

### EXPERIMENTAL RESULTS

The effect of the context size on the compilation speed for two tasks has been tested. The first task is a grammar (list of stock names) with 8335 states and 22078 arcs. The acoustic vocabulary has 8 k words and 24 k lexemes. The second task in an n-gram language model (switchboard task) with 1.7M of 2-grams, 1.2M of 3-grams 86 k of 4-grams, with a vocabulary of 30 k words and 32.5 k lexemes. The compilation time was measured on a LINUX™ workstation with 3 GHz Pentium 4 CPUs and 2.0 GB of memory and is shown is table 1.

TABLE 1
Compilation time (in seconds) for various left context size s

| Context-size | Grammar | n-gram |
|---|---|---|
| 0 | 2 | 34 |
| 1 | 5 | 51 |
| 2 | 57 | 216 |
| 3 | 314 | 1306 |
| 4 | 767 | 3560 |

While the efficiency suffers when the context size increases, the computation is sped up for large contexts by relaxing the vocabulary independence requirement and precomputing the effective number of unique contexts. Given a fixed vocabulary, the number of contexts is limited by the number of unique combinations of last n phones of all words. But, some of the contexts will have the same cross word context effect. For those contexts only one context prefix tree needs to be built. Table 2 compares the limit and effective values of context classes on both tasks. The effective value can be found as the number of tree roots in an expansion of a unigram model. This expansion is in fact a part of any backoff n-gram graph compilation and represents the most time consuming part of the expansion.

TABLE 2
Comparison between the upper limit and the actual
number of unique contexts in a vocabulary constrained system

| Context | Grammar | Grammar | n-gram | n-gram |
|---|---|---|---|---|
| Size | Limit | Effective | Limit | Effective |
| 1 | 51 | 49 | 43 | 42 |
| 2 | 966 | 872 | 654 | 649 |
| 3 | 5196 | 3911 | 4762 | 2790 |
| 4 | 12028 | 6069 | 13645 | 3514 |

A much larger n-gram model was employed to test the memory needs of the process. While keeping the total memory use below 2 GB, a language model was compiled into a graph with 35M states and 85M arcs.

A system and method for memory efficient decoding graph construction have been presented. By eliminating intermediate processing, the memory need of the present embodiments is proportional to the number of states and arcs of the final minimal graph. This is very computationally efficient for short left crossword contexts (and unlimited intra-word context size), but it can also be used to compile graphs for a wide left crossword context without sacrificing the memory efficiency.

Having described preferred embodiments of memory efficient decoding graph compilation system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

1. A method for building decoding graphs for speech recognition, comprising the steps of:
providing a state prefix tree for each unique acoustic context;
traversing the trees to select a subtree of arcs and states to be added to a final decoding graph wherein the states and arcs are added incrementally during the traversing step such that the final graph is constructed deterministically and minimally during the traversing step.

2. The method as recited in claim 1, wherein the step of traversing includes traversing the graph from active words to a root in each prefix tree.

3. The method as recited in claim 1, wherein the step of providing further comprises the step of selecting subtrees from the trees which correspond to words active in a given grammar state.

4. The method as recited in claim 3, wherein the step of traversing further comprises the step of visiting only states, which are part of a selected subtree.

5. The method as recited in claim 1, further comprising the step of utilizing a left cross-word context.

6. The method as recited in claim 1, wherein the step of providing includes sorting states of the prefix trees based on their position in the prefix tree.

7. The method as recited in claim 6, wherein the step of traversing includes checking whether a level of a currently traversed state has been achieved before, and if it has been achieved, merging the previously achieved state of the same level into the final graph.

8. The method as recited in claim 6, further comprising the step of merging all active word states into the final graph.

9. The method as recited in claim 1, further comprising the step of pushing weight costs during the traversing step.

10. A program storage device readable by machine, tangibly embodying a program of instructions executable by the machine to perform method steps for building decoding graphs in speech recognition systems, as recited in claim 1.

11. A method for building decoding graphs for speech recognition, comprising the steps of:
assigning a context class to each lexeme provided in decoding of speech;
constructing a prefix tree for each unique context class;
for each grammar state affected by the context, selecting subtrees by traversing the prefix trees to identify arcs and states to be added to a final decoding graph wherein the states and arcs are added incrementally during the traversing step such that the final graph is constructed deterministically and minimally during the traversing step.

12. The method as recited in claim 11, wherein the step of traversing includes traversing the graph from active words to a root in each prefix tree.

13. The method as recited in claim 11, wherein the step of traversing further comprises the step of visiting only states, which are part of a selected subtree.

14. The method as recited in claim 11, wherein the context includes a left cross-word context.

15. The method as recited in claim 11, wherein the step of providing includes sorting states of the prefix trees based on their position in the prefix tree.

16. The method as recited in claim 15, wherein the step of traversing includes checking whether a level of a currently traversed state has been achieved before, and if it has been achieved, merging the previously achieved state of the same level into the final graph.

17. The method as recited in claim 15, further comprising the step of merging all active word states into the final graph.

18. The method as recited in claim 11, further comprising the step of pushing weight costs during the traversing step.

19. A program storage device readable by machine, tangibly embodying a program of instructions executable by the machine to perform method steps for building decoding graphs in speech recognition systems, as recited in claim 11.

20. A system for speech recognition, comprising:
a module which generates a state prefix tree for each unique acoustic context; and
a module which traverses the trees to select a subtree of arcs and states to be added to a final decoding graph wherein the states and arcs are added incrementally during the traversing such that the final graph is constructed deterministically and minimally during the traversing.

21. The system as recited in claim 20, wherein the module which traverses includes a combination of read only memory and random access memory.

22. The system as recited in claim 20, wherein the module which generates a state prefix tree selects subtrees from the trees which correspond to words active in a given grammar state.

23. The system as recited in claim 22, wherein the module, which traverses, visits only states which are part of a selected subtree.

24. The system as recited in claim 20, wherein the context includes a left cross-word context.

25. The system as recited in claim 20, wherein the module which traverses checks whether a level of a currently traversed state has been achieved before, and if it has been achieved, merges a previously achieved state of the same level into the final graph.

26. The system as recited in claim 20, wherein the module, which traverses pushes weight, costs during traversal of the subtrees.
